(19) United States
(12) Patent Application Publication
(10) Pub. No.: US 2019/0318327 A1
(43) Pub. Date: Oct. 17, 2019

(54) SYSTEMS, METHODS, AND COMPUTER PROGRAMS FOR USING A BLOCKCHAIN MARKETPLACE

(71) Applicant: Krambu Inc., Dalton Gardens, ID (US)

(72) Inventors: Lawrence Sowell, Coeur d'Alene, ID (US); Benjamin Meyer, Spokane, WA (US)

(21) Appl. No.: 16/298,915

(22) Filed: Mar. 11, 2019

Related U.S. Application Data
(60) Provisional application No. 62/656,293, filed on Apr. 11, 2018.

(51) Int. Cl. G06Q 20/06; G06Q 30/02; H04L 9/06; G06F 9/50

(52) U.S. Cl. CPC G06Q 20/0655; G06F 9/5055; H04L 9/0637; G06Q 30/0208

(57) ABSTRACT

A system, method, and computer program product are provided for using a blockchain marketplace. In use, a centralized blockchain marketplace is accessed. Additionally, one or more blockchain offers are selected via the centralized blockchain marketplace, and one or more nodes are selected to process the one or more blockchain offers. Further, the one or more nodes are managed based on progress metrics associated with each of the one or more blockchain offers.

### CROSS-REFERENCES TO RELATED APPLICATIONS

The present application is a continuation of, and claims priority to U.S. Provisional Patent Application No. 62/656,293, titled “SYSTEMS, METHODS, AND COMPUTER PROGRAMS FOR USING A BLOCKCHAIN MARKETPLACE,” filed Apr. 11, 2018. The foregoing application is herein incorporated by reference in its entirety for all purposes.

### FIELD OF THE INVENTION

The present invention relates to blockchain, and more particularly to using a marketplace for blockchains.

### BACKGROUND

Typically, mining blockchain technology involves using a computer CPU or video processing card, which is often owned and used by the same entity. However, as blockchain mining has increased in complexity over time, custom application specific integrated circuit (“ASIC”) chips have been introduced to improve the efficiency of mining blockchain technology. Although such systems have improved the efficiency of mining, mining systems generally are managed on a per-user, per-customer, or per-system basis. For example, if a company wishes to contract out a blockchain operation to ten separate entities, such company would have to individually manage each of the ten separate entities. Such an approach can be laborious and tedious.

As such, there is a need to improve the overall efficiency of using hardware and integrated circuits for mining blockchain technology. Additionally, there is a need to create a blockchain distributed marketplace and/or resolve other issues associated with the prior art.

### SUMMARY

A system, method, and computer program product are provided for using a blockchain marketplace. In use, a centralized blockchain marketplace is accessed. Additionally, one or more blockchain offers are selected via the centralized blockchain marketplace, and one or more nodes are selected to process the one or more blockchain offers. Further, the one or more nodes are managed based on progress metrics associated with each of the one or more blockchain offers.

In a first embodiment, the one or more nodes may include users, miners, hardware systems, or an application specific integrated circuit (ASIC). Additionally, the one or more blockchain offers may originate from one of a provider or a developer. Further, each of the one or more nodes may be associated with a commitment level, such that a pre-allocated amount of available resources is designated for each of the one or more nodes, and the pre-allocated amount of available resources may include hashing power.

In a second embodiment (which may or may not be combined with the first embodiment), the centralized blockchain marketplace may receive each of the one or more blockchain offers as a mining package. Additionally, the centralized blockchain marketplace may ensure that the mining package satisfies a compliance associated with the centralized blockchain marketplace.

In a third embodiment (which may or may not be combined with the first and/or second embodiments), the managing the one or more nodes may include allocating hashing power associated with each of the one or more nodes. The hashing power may be re-allocated at a later time period. Additionally, the managing the one or more nodes may include defining a threshold for each of the one or more blockchain offers, and the threshold may be defined by specifying a hashing command hashing power for each of the one or more blockchain offers. Further, the centralized blockchain marketplace may automatically propose automatic reallocation of the hashing commands, and implementing the automatic reallocation may be dependent on receiving an approval from a user.

In a fourth embodiment (which may or may not be combined with the first, second, and/or third embodiments), the progress metrics may include at least one of a hashing power associated with each of the one or more nodes, an electricity consumption rate associated with each of the one or more nodes, a processor load associated with each of the one or more nodes, a time to completion associated with each of the one or more nodes, a reward level associated with each of the one or more nodes, a difficulty of the blockchain offer processed by each of the one or more nodes, a collaboration of more than one node of the one or more nodes, a time spent on the one or more blockchain offers associated with each of the one or more nodes, an up-time associated with each of the one or more nodes, a connection rate associated with each of the one or more nodes, or a price per hashing power associated with each of the one or more nodes.

In a fifth embodiment (which may or may not be combined with the first, second, third, and/or fourth embodiments), the one or more processors may execute the instructions to display an indication of a completion of one of the one or more blockchain offers. In response to the completion, a payment may be processed and delivered to the owner of the respective one or more nodes.

In a sixth embodiment (which may or may not be combined with the first, second, third, fourth, and/or fifth embodiments), the centralized blockchain marketplace may be used to receive a solicitation or bid for one of the one or more blockchain offers. Additionally, two nodes of the one or more nodes may be selected to process the selected one or more blockchain offers.

To this end, in some optional embodiments, one or more of the foregoing features of the aforementioned method may allow for a blockchain marketplace that allows for more efficient management, and greater accuracy of tracking blockchain progress. In addition, various embodiments may allow for managing bids for one or more blockchain offers to be serviced by a node with hashing power. Further, other embodiments may allow use of the centralized blockchain marketplace to allocate specific resources (e.g. hashing power) for blockchain use. These potential advantages would otherwise be foregone in systems that isolate blockchain processing and/or management, and that distribute blockchain offers among nodes owned and managed by a separate entity. It should be noted that the aforementioned potential advantages are set forth for illustrative purposes only and should not be construed as limiting in any manner.

### BRIEF DESCRIPTION OF THE DRAWINGS

FIG. 1 illustrates a method for managing nodes of a blockchain marketplace, in accordance with one embodiment.

FIG. 2 illustrates a blockchain marketplace, in accordance with one embodiment.

FIG. 3 illustrates a method of user side flow of the blockchain marketplace, in accordance with one embodiment.

FIG. 4 illustrates a method of publishing a mining package on the blockchain marketplace, in accordance with one embodiment.

FIG. 5 illustrates a method for changing hashing power of the blockchain marketplace, in accordance with one embodiment.

FIG. 6 illustrates a method of automatic management of the blockchain marketplace, in accordance with one embodiment.

FIG. 7 illustrates a method for offering blockchains using the blockchain marketplace, in accordance with one embodiment.

FIG. 8 illustrates a method for uploading blockchains on the blockchain marketplace, in accordance with one embodiment.

FIG. 9 illustrates a method for providing services to a blockchain miner via the blockchain marketplace, in accordance with one embodiment.

FIG. 10 illustrates a network architecture, in accordance with one possible embodiment.

FIG. 11 illustrates an exemplary system, in accordance with one embodiment.

### DETAILED DESCRIPTION

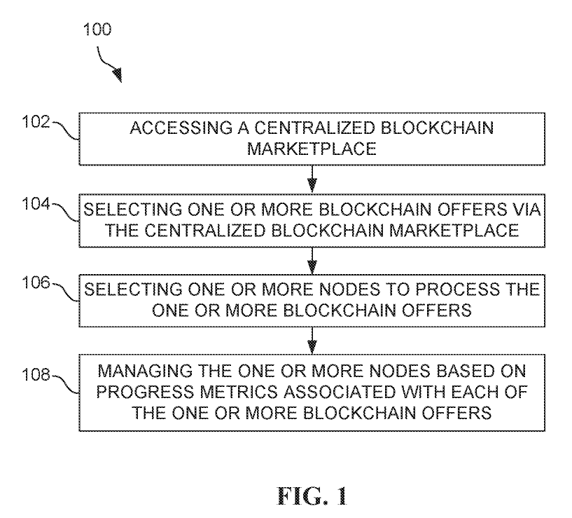

FIG. 1 illustrates a method 100 for managing nodes of a blockchain marketplace, in accordance with one embodiment.

As shown, a centralized blockchain marketplace is accessed. See operation 102. In the context of the present description, a centralized blockchain marketplace is a centralized database for blockchain and/or data blocks secured by cryptography. For example, the centralized blockchain marketplace may be used to upload action items (e.g. blockchain offers) and/or any input string, manage uploaded items, solicit and/or bid to work (i.e. use hashing power to mine blockchains), and/or otherwise be a central repository whereby miners and developers can interact. Of course, it is to be appreciated that such examples are not intended to be limiting in any manner, as the blockchain marketplace may encompass any centralized aspect of blockchains.

In the context of the present description, a developer is an entity that provides blockchain action items to the centralized blockchain marketplace. In like manner, a miner is an entity that provides hashing power to be applied to the blockchain action items of the centralized blockchain marketplace.

Additionally, one or more blockchain offers are selected via the centralized blockchain marketplace. See operation 104. In the context of the present description, a blockchain offer is any type of data block secured by cryptography. For example, in one embodiment, a blockchain offer may include a financial institution (or a developer) with internal security blockchains. Such blockchain offer may be uploaded to the centralized blockchain marketplace where potential miners may then view and accept such blockchain offers to which hashing power can be applied.

Further, one or more nodes are selected to process the one or more blockchain offers. See operation 106. In the context of the present description, a node is an amount of hashing power. For example, a node may include a disparate device capable of mining blockchain(s), an allocated amount of hashing power from a blockchain farm (e.g. a server farm with mining capabilities), and/or any processing power which can be applied towards mining.

In one embodiment, each of the one or more nodes may be associated with a separate miner, or in another embodiment, may be associated with the same miner. In this manner, each of the one or more nodes may be associated with an individual, an entity, a corporation, etc.

In addition, the one or more nodes are managed based on progress metrics associated with each of the one or more blockchain offers. See operation 108. For example, managing the one or more nodes may include engaging with new nodes, disabling use of another node, allocating more or retracting hashing power from a node, aggregating hashing power from more than one node, and/or taking any action with respect to a node.

Additionally, the progress metrics may include at least one of a hashing power (or hash rate), an electricity consumption rate, a processor load, a time to completion, a reward level, a difficulty of the blockchain, a collaboration of more than one node (i.e. interaction between more than one miner assigned to mine a blockchain), a time spent on the blockchain offer(s), an up-time, a connection rate, and/or a price per hashing power.

In one embodiment, the one or more nodes may be manually managed, for example, through manual interaction of a miner and/or developer. Alternatively, the one or more nodes may be automatically optimized and/or actions automatically taken. For example, if electricity rates for a particular node increased, the blockchain marketplace may automatically allocate the hashing power for the associated blockchain offer to another node. Such automatic action may be based on pre-determined thresholds and/or criteria inputted by the developer and/or miner. In another embodiment, an approval and/or authorization must be received by the developer and/or miner before the automatic action is implemented by the blockchain marketplace.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

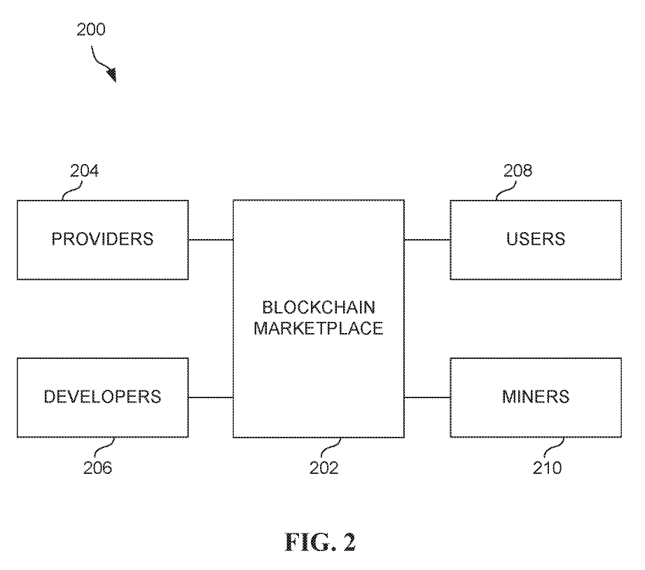

FIG. 2 illustrates a blockchain marketplace 200, in accordance with one embodiment. As an option, the blockchain marketplace 200 may be implemented in the context of any one or more of the embodiments set forth in any previous and/or subsequent figure(s) and/or description thereof. Of course, however, the blockchain marketplace 200 may be implemented in the context of any desired environment. Further, the aforementioned definitions may equally apply to the description below.

As shown, the blockchain marketplace 202 is connected to providers 204, and developers 206, both of which may provide blockchains and/or work items to the blockchain marketplace 202. In one embodiment, the providers 204 and developers 206 may include an entity interested in launching a blockchain. Additionally, the blockchain marketplace may be connected to users 208 and miners 210, both of which provide resources (e.g. hash power, hash rate, etc.) to the blockchain marketplace 202. In one embodiment, the users 208 and miners 210 may include an entity with mining hardware capable of processing blockchains.

The blockchain marketplace 202 may enable an environment where pricing is based off blockchain offers (as dictated, e.g., by providers 204 and/or developers 206) rather than being set by an external source (such as the centralized blockchain marketplace). Such a marketplace would provide therefore a real market (subject to supply/demand type constraints) for blockchains, including private blockchains. For example, the marketplace may include any number of different private blockchains offering pay for processing power. Such an offer may be set at a price dictated by providers, developers, users, and/or miners of the blockchain market. A first company may offer $50/MH for three years where another company may offer $48/MH for the same period. As such, a natural environment may be established for the exchange of offers relating to blockchains.

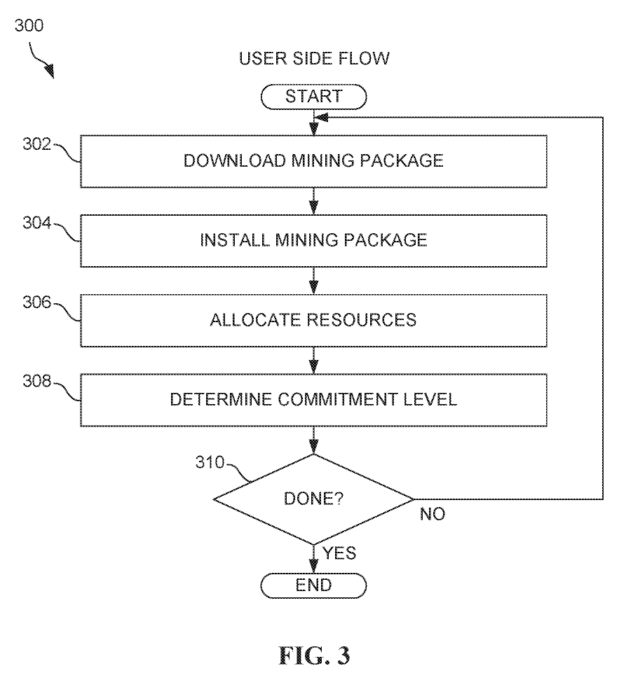

FIG. 3 illustrates a method 300 of user side flow of the blockchain marketplace, in accordance with one embodiment. As an option, the method 300 may be implemented in the context of any one or more of the embodiments set forth in any previous and/or subsequent figure(s) and/or description thereof. Of course, however, the method 300 may be implemented in the context of any desired environment. Further, the aforementioned definitions may equally apply to the description below.

As shown, method 300 starts with an entity downloading mining package. See operation 302. The mining package may include an offer and/or request for action relating to a blockchain. Additionally, the mining package may be installed. See operation 304. Such an installation may include installing the mining package onto one or more nodes associated with an entity.

Additionally, resources may be allocated. See operation 306. The allocation may include allocating hashing power to the installed mining package. In this manner, the entity (e.g. owner of the node(s), etc.) may use all or part of the total hashing power of the node(s). The commitment level may then be determined. See operation 308. For example, the commitment level may include a commitment to mine the mining package for a set amount of time, or at a minimum amount of hashing power, etc. Additionally, the commitment level may include presenting one or more predetermined parameters (as set by the developer) associated with mining the mining package to the miner for acceptance.

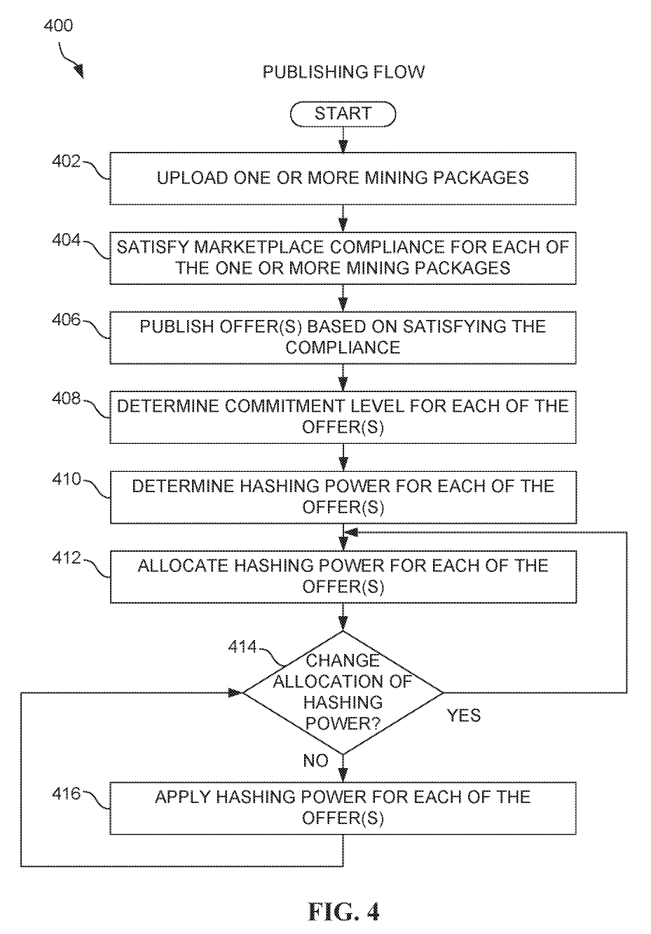

FIG. 4 illustrates a method 400 of publishing a mining package on the blockchain marketplace, in accordance with one embodiment. As an option, the method 400 may be implemented in the context of any one or more of the embodiments set forth in any previous and/or subsequent figure(s) and/or description thereof. Of course, however, the method 400 may be implemented in the context of any desired environment. Further, the aforementioned definitions may equally apply to the description below.

The method 400 begins with uploading one or more mining packages. See operation 402. Such uploading may include transferring the one or more mining packages to the centralized blockchain marketplace. Additionally, the uploading may include connecting to a central database (e.g. via a website, etc.) and transferring one or more mining packages to the central database. In another embodiment, the uploading may include sending the one or more mining packages via email (or another communication method) such that the central database receives the package through a communication protocol (e.g. SMTP, HTTP, POPS, IMAP, etc.). Further, the one or more mining packages may include at least one offer.

After the one or more mining packages are uploaded, the marketplace ensures that each of the one or more packages satisfy a compliance. See operation 404. For example, the one or more mining packages may be verified and validated by the centralized blockchain marketplace to ensure that the code and/or request(s) in the one or more packages are free of virus and/or other malicious code. Additionally, the compliance may include ensuring that basic parameters (e.g. source of package, identity of the developer, valid hash function(s), etc.) are satisfied. These basic parameters may be predetermined and set by an administrator of the blockchain marketplace.

Offer(s) may be published based on satisfying the compliance. See operation 406. The offer(s) may be determined based on the number of mining packages, and/or the number of packages that have satisfied the marketplace compliance. Next, a commitment level is determined for each of the offer(s). See operation 408. For example, in order to accept the uploaded offer(s), the developer may set a minimum level of commitment (e.g. amount of hashing power, amount of time, etc.) associated with such offer(s).

The hashing power is determined for each of the offer(s). See operation 410. For example, an offer may require a minimum amount of hashing power, or in another embodiment, a developer may indicate an amount of time by which the blockchain should be mined and a recommended hashing power that would be needed to mine such blockchain by the indicated time deadline.

In another embodiment, after an offer has been accepted by a miner for processing/mining, the developer may view in real-time the hashing power for each of the accepted offer(s).

The hashing power may be allocated for each of the offer(s). See operation 412. For example, the developer may view the current hashing power being applied for each of the offer(s). Allocating hashing power may be based and tied directly to a commitment level. For example, a miner may post to the marketplace available hashing power for a developer to potentially use. Such commitment therefore (of operation 408) may include a miner dedicating a set amount of hashing power for a set time period. In this context, the allocation of operation 412 may include a developer apportioning hashing power amongst one or more offer(s) associated with the one or more mining packages.

It is determined whether a change of allocation of hashing power is needed. See decision 414. If yes, the operation goes to operation 412 to allocate the hashing power for each of the offer(s). If not, the operation proceeds to operation 416 where the hashing power is applied for each of the offer(s).

As an example, a developer may upload one or more mining packages corresponding to blockchain work. After ensuring compliance of such packages, the marketplace may publish the packages such that potential miners can accept to work on the packages. In an alternative, the developer may view available hashing power on the marketplace (by other miners) and may accept commitment levels from the available hashing power to be applied to the one or more mining packages. After the one or more mining packages commence to be mined, the developer may still control the allocation of hashing power amongst the committed hashing power to the developer. In this manner, even if a miner accepts to work on a first blockchain package, the allocated hashing power committed by the miner to a developer may in fact be used by a second or another blockchain package at a later time period, as dictated by the developer. For example, a miner may commit a predetermined hashing power to a developer for a period of 5 months. After 2 months, the first of the blockchain offer may be completed, so the developer may allocate another blockchain offer to be worked on by the predetermined hashing power. The developer can therefore modify and allocate the hashing power amongst the one or more mining packages that have been uploaded and approved of by the blockchain marketplace.

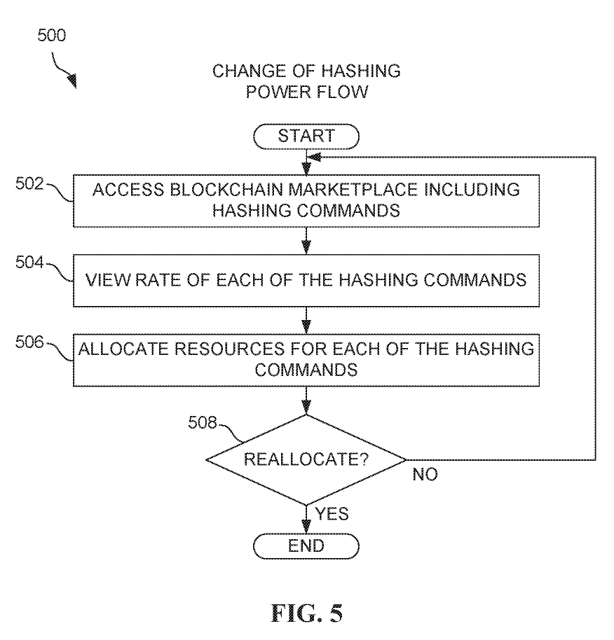

FIG. 5 illustrates a method 500 for changing hashing power of the blockchain marketplace, in accordance with one embodiment. As an option, the method 500 may be implemented in the context of any one or more of the embodiments set forth in any previous and/or subsequent figure(s) and/or description thereof. Of course, however, the method 500 may be implemented in the context of any desired environment. Further, the aforementioned definitions may equally apply to the description below.

Method 500 begins with accessing the blockchain marketplace including hashing commands. See operation 502. Additionally, on the blockchain marketplace, a rate of each of the hashing commands may be viewed. See operation 504. Resources may be allocated for each of the hashing commands. See operation 506. For example, one or more nodes may be allocated to satisfy the hashing commands. Such nodes may be owned by the developer, or may be owned by separate entity(ies) that provide the hashing power to the developer for use in mining.

It may then be determined whether to reallocate the resources. See decision 508. For example, if a resource goes offline (or otherwise becomes unavailable), the developer may change the resources such that the remaining available resources may be reallocated amongst all of the hashing commands. In an alternative embodiment, a developer may engage additional miners (e.g. available hashing power) and then may allocate such available resources to any of the hashing commands. In this manner, if it is determined to reallocate the resources, the method goes back to operation 502.

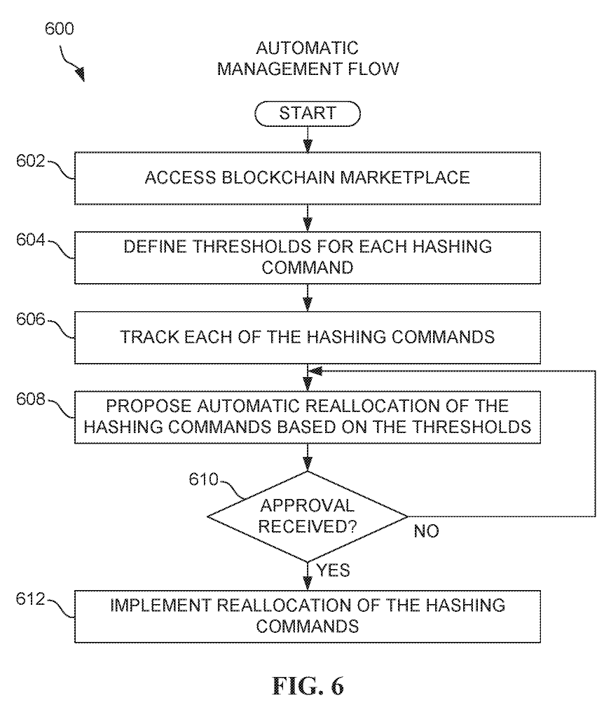

FIG. 6 illustrates a method 600 of automatic management of the blockchain marketplace, in accordance with one embodiment. As an option, the method 600 may be implemented in the context of any one or more of the embodiments set forth in any previous and/or subsequent figure(s) and/or description thereof. Of course, however, the method 600 may be implemented in the context of any desired environment. Further, the aforementioned definitions may equally apply to the description below.

Method 600 begins with accessing the blockchain marketplace. See operation 602. Thresholds may be defined for each hashing command. See operation 604. For example, a threshold may be a time deadline, a minimum threshold power, etc. Each of the hashing commands may be tracked. See operation 606. For example, tracking may include showing a progress of the hashing commands (e.g. percent done, etc.), an average hashing power applied to the hashing command, a breakdown of the source (e.g. node) of the hashing command, a historical view of the work performed by a node (or miner), etc.

An automatic reallocation of the hashing commands may be proposed based on the thresholds. See operation 608. For example, if a node falls below a hashing power, the blockchain marketplace may automatically determine that the hashing power has fallen below a hashing power threshold and find another node (with hashing power over the threshold) that can comply with the predetermined threshold.

In one embodiment, it is determined whether approval is received. See decision 610. For example, in one embodiment, to comply with governmental regulations, express approval may be requested of the developer/owner such that the automatic reallocation requires a manual approval of such an action. If approval is not received, or if the approval is rejected, then the method goes back to operation 608 to come up with an alternative (or the best) proposal.

If approval has been received (per decision 610), then the reallocation of the hashing commands is implemented. See operation 612.

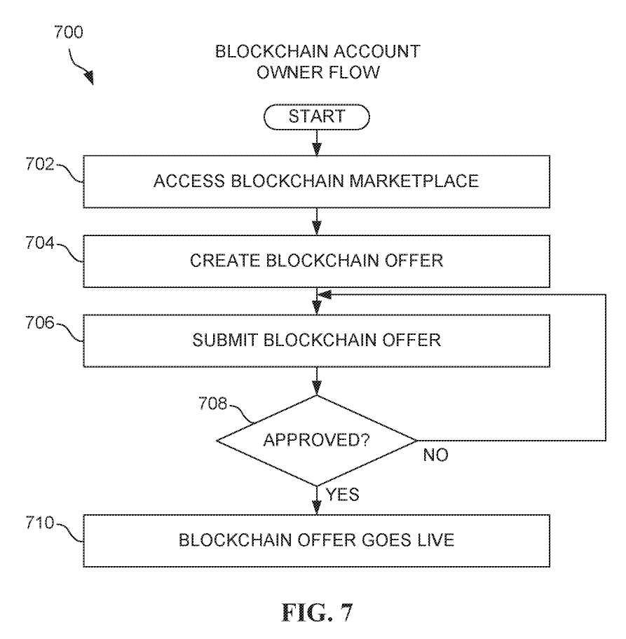

FIG. 7 illustrates a method 700 for offering blockchains using the blockchain marketplace. As an option, the method 700 may be implemented in the context of any one or more of the embodiments set forth in any previous and/or subsequent figure(s) and/or description thereof. Of course, however, the method 700 may be implemented in the context of any desired environment. Further, the aforementioned definitions may equally apply to the description below.

Method 700 includes accessing the blockchain marketplace. See operation 702. Accessing the blockchain marketplace may include navigating to a website or using an app associated with the blockchain marketplace, creating a user account (and agreeing to policies/terms), inputting two factor authentication, etc. A blockchain offer may also be created. See operation 704. In one embodiment, the creation of a blockchain offer may include uploading one or more mining packages. Additionally, a blockchain offer may use one or more parameters or features from a previously created blockchain offer (e.g. items may be copied and/or duplicated from a previously created blockchain offer). In this manner, one or more features (e.g. prior selections) may be associated with a user account.

Additionally, the blockchain offer may specify a predetermined amount (e.g. $XX, etc.) for a specific amount of blockchain processing (e.g. in Megahash, or Solhash, etc.) or otherwise indicate that the offer is an onchain processing (e.g. Ethereum, etc.) for decentralized blockchains. Further, the blockchain offer may specific a minimum and/or maximum hash rate per miner (e.g. node, resource, etc.), and/or may include blockchain mining client code.

The blockchain offer may then be submitted to the blockchain marketplace. See operation 706. After submitting, it is determined whether the blockchain offer is approved. See decision 708. For example, an administrator associated with the blockchain marketplace may review and accept or deny the submission.

If the offer is accepted, then per operation 710, the blockchain offer goes live. If the offer is denied, then the method returns back to operation 706 so that the developer can review the reasons for the denial, and resubmit the blockchain offer for approval.

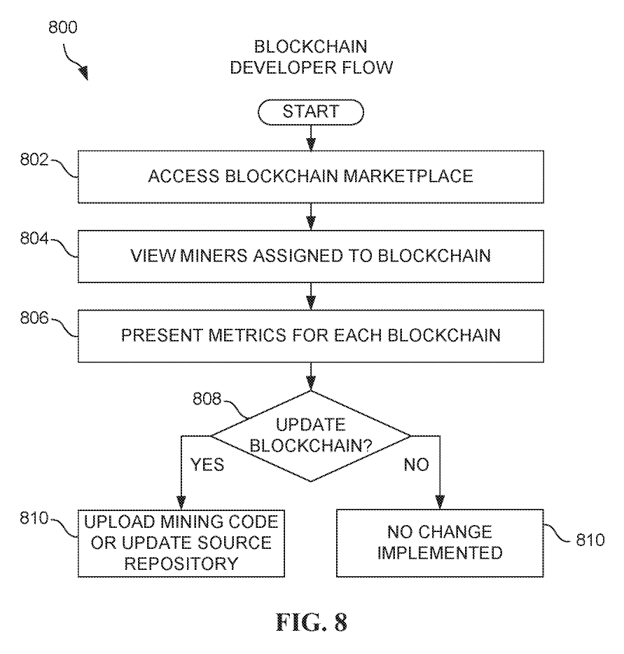

FIG. 8 illustrates a method 800 for uploading blockchains on the blockchain marketplace, in accordance with one embodiment. As an option, the method 800 may be implemented in the context of any one or more of the embodiments set forth in any previous and/or subsequent figure(s) and/or description thereof. Of course, however, the method 800 may be implemented in the context of any desired environment. Further, the aforementioned definitions may equally apply to the description below.

As shown, method 800 includes accessing blockchain marketplace. See operation 802. The miners may be viewed that are assigned to a blockchain. See operation 804. Additionally, metrics may be presented for each blockchain. See operation 806. For example, metrics may include current statistics, historical statistics, location-based information, and/or any other information associated with the processing of the blockchain. Further, an aggregate hashrate of a blockchain may also be presented. Such metrics may include historical data, and/or real time analytics.

It is determined whether the blockchain needs to be updated. See decision 808. For example, the blockchain may need to be updated (in which case method 700 may be invoked) and resubmitted. Additionally, a blockchain offer may be added.

If the blockchain does not require updates, then no change is implemented per operation 810. If the blockchain does require an update, then per operation 810, mining code is uploaded and/or source repository is updated. After uploading and/or updating the blockchain, then via operation 706, the blockchain offer may be resubmitted to the blockchain marketplace for approval. In another embodiment, updates to the blockchain may include notifications and/or other blockchain settings which may not require resubmittal to the blockchain marketplace for approval.

In one embodiment, the blockchain marketplace may allow near-instant access to a network of distributed, coordinated miners. Additionally, the blockchain marketplace may allow for easier development (e.g. of offers, mining projects), increased security (e.g. compliance requirements, etc.), as well as increased stability, reliability, privacy and efficiency.

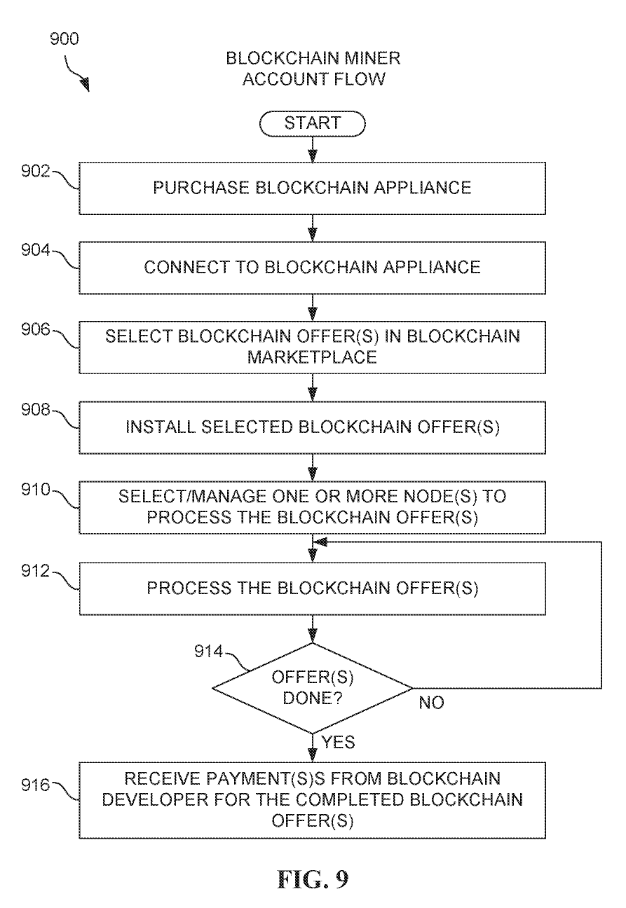

FIG. 9 illustrates a method 900 for providing services to a blockchain miner via the blockchain marketplace, in accordance with one embodiment. As an option, the method 900 may be implemented in the context of any one or more of the embodiments set forth in any previous and/or subsequent figure(s) and/or description thereof. Of course, however, the method 900 may be implemented in the context of any desired environment. Further, the aforementioned definitions may equally apply to the description below.

Method 900 includes purchasing a blockchain appliance. See operation 902. In the context of the present description, a blockchain appliance includes a node capable of processing a blockchain. For example, a blockchain appliance may include creating a node or resource for mining operations, or otherwise putting together a device capable of mining operations. In another embodiment, the blockchain appliance may include purchasing a hosted device for mining operations, or a set amount of hashing power from a blockchain appliance. Still yet, an application on a blockchain appliance may be licensed such that an amount of hashing power may be licensed for a set amount of time (or up to a set amount of predetermined hashing power).

A miner may then connect to the blockchain appliance. See operation 904. For example, connecting to the blockchain appliance may include turning on the blockchain appliance (either manually or via an appliance service), and/or configuring such appliance with a license. Additionally, the miner may create a user account, agree to marketplace policy(ies)/terms, satisfy account compliance, etc.

The miner may select blockchain offer(s) in the blockchain marketplace. See operation 906. For example, the blockchain marketplace may allow for miners to browse all blockchain offers, including currently available offers, as well as offers that are already engaged (but which are open for additional bidding). In one embodiment, selecting a blockchain offer may include placing a bid to engage work on the selected blockchain offer.

The selected blockchain offer(s) may then be installed. See operation 908. For example, the selected blockchain offer(s) may be installed on the blockchain appliance (e.g. from operations 902 and 904). In one embodiment, as part of the installation process, the miner may also connect up a digital wallet or bank account for receiving credits associated with completing such blockchain offer(s).

The one or more nodes(s) may be selected/managed to process the blockchain offer(s). See operation 910. For example, after choosing to process a blockchain offer, the miner may select which node(s) (or blockchain appliance(s)) to use to process such blockchain offer. The blockchain offer(s) may then be processed. See operation 912. It is determined whether the offer(s) has completed. See decision 914. If the processing is not yet complete, the process continues via operation 912. If the processing has completed, then payment(s) are received from blockchain developer for the completed blockchain offer(s). See operation 916. For example, payments may be received either on-chain or off-chain relating to the processing.

In various embodiments, the blockchain marketplace may allow for searching of specific offer(s), appliance(s), system capabilities, blockchain requirements, hashing power, etc. Additionally, such a blockchain marketplace may provide the ability for miners to hash for private blockchain providers, as well as for blockchain offers to be installed by miners.

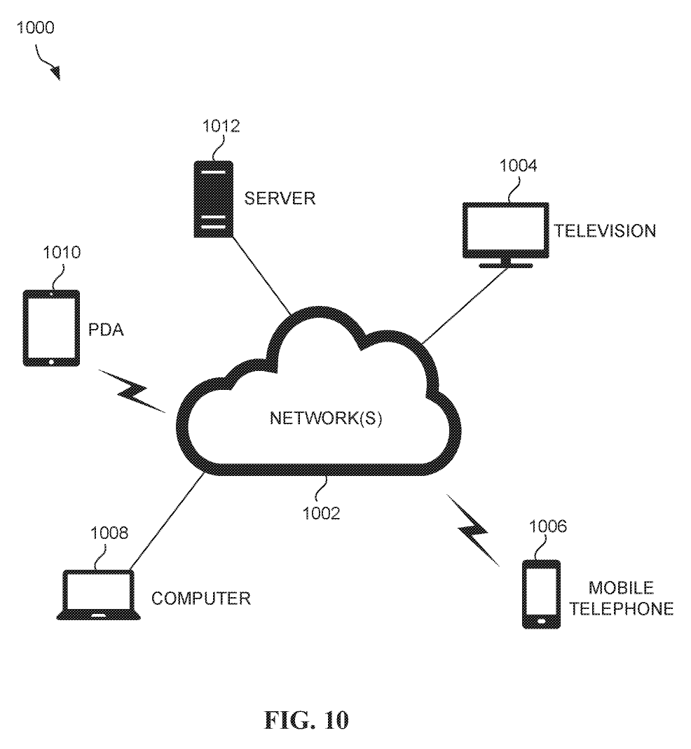

FIG. 10 illustrates a network architecture 1000, in accordance with one possible embodiment. As shown, at least one network 1002 is provided. In the context of the present network architecture 1000, the network 1002 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 1002 may be provided.

Coupled to the network 1002 is a plurality of devices. For example, a server computer 1012 and an end user computer 1008 may be coupled to the network 1002 for communication purposes. Such end user computer 1008 may include a desktop computer, lap-top computer, and/or any other type of logic. Still yet, various other devices may be coupled to the network 1002 including a personal digital assistant (PDA) device 1010, a mobile phone device 1006, a television 1004, etc.

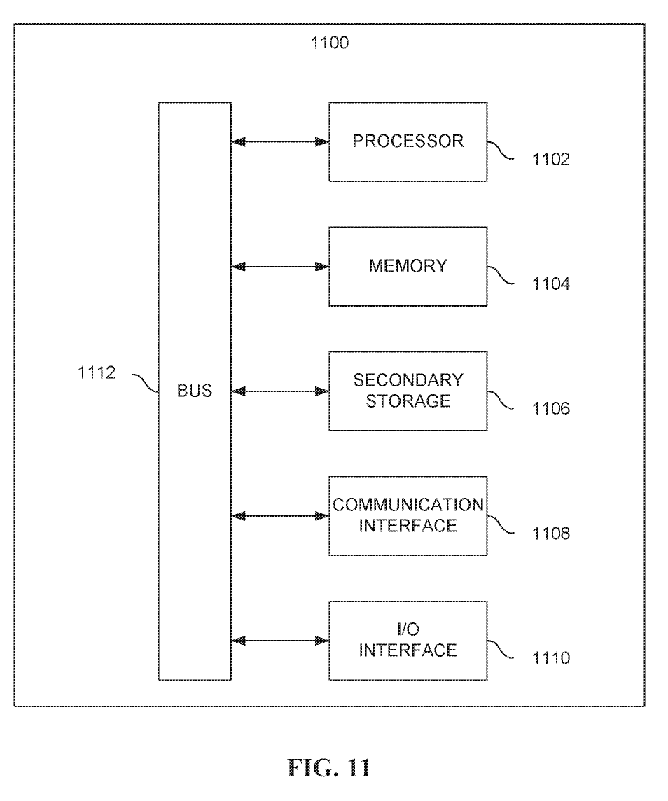

FIG. 11 illustrates an exemplary system 1100, in accordance with one embodiment. As an option, the system 1100 may be implemented in the context of any of the devices of the network architecture 1000 of FIG. 10. Of course, the system 1100 may be implemented in any desired environment.

As shown, a system 1100 is provided including at least one central processor 1102 which is connected to a communication bus 1112. The system 1100 also includes main memory 1104 [e.g. random access memory (RAM), etc.]. The system 1100 also includes a graphics processor 1108 and a display 1110.

The system 1100 may also include a secondary storage 1106. The secondary storage 1106 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 1104, the secondary storage 1106, and/or any other memory, for that matter. Such computer programs, when executed, enable the system 1100 to perform various functions (as set forth above, for example). Memory 1104, storage 1106 and/or any other storage are possible examples of non-transitory computer-readable media.

In various embodiments, the blockchain marketplace may be used for hash hopping. For example, a first blockchain (e.g. associated with Bitcoin) may be mined, but the hashing power applied to such a first blockchain may be diverted to a second blockchain (e.g. associated with Ethereum). As such, real-time, on-the-fly management of blockchains may be achieved using the blockchain marketplace. Additionally, the blockchains may relate specifically to coins.

In another embodiment, a first company may have need of a centralized and distributed system. Using the blockchain marketplace, customers can upload offers associated with the first company and miners may load such offers into their blockchain machines to hash the algorithm associated with such offers.

In one embodiment, the nodes and/or resources may include servers associated with a distributed centralized network. In this manner, processing power may be sold via the blockchain marketplace. Additionally, appliances bought via the blockchain marketplace may be used such that the provider may upload any operating system (or mining theory) to provide hashing power or capability to be sold via the blockchain marketplace. In this manner, the blockchain marketplace may act like an intermediary between providers (developers) and miners (users). Still yet, the blockchain marketplace may include offers (different block chains) that can be processed by a miner. In one embodiment, the blockchain marketplace may already have pre-uploaded coins to mine which the miners can select to mine.

In another embodiment, the blockchain marketplace may include software to send and receive data associated with a blockchain. Additionally, the blockchain marketplace may function as a distributed and centralized system and would allow customers (e.g. entities) to have one place (a centralized location) where blockchain needs can be uploaded, allocated to miners, and managed. In contrast, current systems may require an entity, using a hypothetical number of miners, to contact and manage each of the miners separately. As such, the blockchain marketplace increases the efficiency, at a minimum, as well as the privacy, security, and reliability of interacting with a variety of miners.

In one embodiment, the blockchain marketplace may include a distribution a hashing commands amongst available nodes and/or resources to mine such hashing commands. Additionally, after choosing to use the blockchain marketplace, updates may occur manually (via a manual download of available offers) or may be kept in-sync with a centralized server. The blockchain marketplace may allow miners to view potential offers to determine, based on their resource capabilities, where the best reward may exist. In one embodiment, the blockchain marketplace may provide recommendations to the miner as to which offers may provide the greatest return on investment based on the hardware configuration of the node and/or resource.

Still yet, in one embodiment, the blockchain marketplace may allow for greater security. For example, with increased hashing power, the developer may have greater security as the hashing power may be more diversified (as oppose to hashing completely using just one system). Further, the blockchain marketplace may allow for greater and more efficient coordination of all blockchain efforts a company may pursue.

In another embodiment, the blockchain marketplace may allow for mining of block chains associated with any type of data (e.g. financial, security, health data files, etc.) within a secure ecosystem. Additionally, mining a blockchain may be associated with a reward such that the longer a miner has mined a specific blockchain (e.g. a coin, private data, etc.), the greater the reward (which would discourage miners otherwise from switching from one blockchain to another).

In one embodiment, the blockchain marketplace may provide the ability to forecast and project revenue associated with mining a blockchain. Such forecasting may directly influence the blockchain marketplace in making recommendations on which blockchain a miner should pursue. Additionally, based on thresholds set by the miner, the blockchain marketplace may propose alternative offers to pursue based on expected reward amounts.

In some embodiments, automation of the recommendation process may include analyzing the difficulty of the blockchain, production needs for the blockchain, and the current and projected value of the coins, and taking an action (or proposed action) which would maximize the financial reward for the miner. If approval is needed, then a request for approval may be sent via a notification on a mobile device, or via another communication means (e.g. email, text, application notification, etc.).

In another embodiment, the blockchain marketplace may allow for flexibility of the developers in that hash power, processing speed, time requirements, etc. may all be dictated by the developer. For example, a developer may indicate a lower hashing power is required, thereby allowing miners with older type equipment to participate at a reward rate proportional to the amount of hashing required and the time in which the hashing is completed.

The blockchain marketplace may be used to aggregate and pull together various types of data, including financial data, clients, processing power, communication data, etc. In one embodiment, the blockchain marketplace may be hardware agnostic.

Additionally, the blockchain marketplace may allow for audit and legal compliance. For example, a hash rate may be linked to a contract (or account) and all hashing power provided (e.g. by the miner) may be tracked for regulatory purposes, if necessary. Further, in one embodiment, the exchange of money may occur through the blockchain marketplace, or may occur independently of the blockchain marketplace. For example, after completing mining a blockchain, a miner may be financially rewarded directly (e.g. by the developer) or through a digital coin reward. In such a manner, the reward to the miner may occur without causing the financial reward to pass (or be stored by) the blockchain marketplace.

In a further embodiment, the blockchain marketplace may include a score associated with each of the offer(s). For example, the score may be based on past success rates, a difficulty rank, reliability of the developer, etc.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A device, comprising:
a non-transitory memory storing instructions; and
one or more processors in communication with the non-transitory memory, wherein the one or more processors execute the instructions to:
access a centralized blockchain marketplace;
select one or more blockchain offers via the centralized blockchain marketplace;
select one or more nodes to process the one or more blockchain offers; and
manage the one or more nodes based on progress metrics associated with each of the one or more blockchain offers.

2. The device of claim 1, wherein the one or more nodes includes users, miners, hardware systems, or an application specific integrated circuit (ASIC).

3. The device of claim 1, wherein the one or more blockchain offers originate from one of a provider or a developer.

4. The device of claim 1, wherein each of the one or more nodes are associated with a commitment level, such that a pre-allocated amount of available resources is designated for each of the one or more nodes.

5. The device of claim 4, wherein the pre-allocated amount of available resources includes hashing power.

6. The device of claim 1, wherein the centralized blockchain marketplace receives each of the one or more blockchain offers as a mining package.

7. The device of claim 6, wherein the centralized blockchain marketplace ensures that the mining package satisfies a compliance associated with the centralized blockchain marketplace.

8. The device of claim 1, wherein managing the one or more nodes includes allocating hashing power associated with each of the one or more nodes.

9. The device of claim 8, wherein the hashing power is re-allocated at a later time period.

10. The device of claim 1, wherein managing the one or more nodes includes defining a threshold for each of the one or more blockchain offers.

11. The device of claim 10, wherein the threshold is defined by specifying a hashing command hashing power for each of the one or more blockchain offers.

12. The device of claim 11, wherein the centralized blockchain marketplace automatically proposes automatic reallocation of the hashing commands.

13. The device of claim 12, wherein implementing the automatic reallocation is dependent on receiving an approval from a user.

14. The device of claim 1, wherein the progress metrics include at least one of a hashing power associated with each of the one or more nodes, an electricity consumption rate associated with each of the one or more nodes, a processor load associated with each of the one or more nodes, a time to completion associated with each of the one or more nodes, a reward level associated with each of the one or more nodes, a difficulty of the blockchain offer processed by each of the one or more nodes, a collaboration of more than one node of the one or more nodes, a time spent on the one or more blockchain offers associated with each of the one or more nodes, an up-time associated with each of the one or more nodes, a connection rate associated with each of the one or more nodes, or a price per hashing power associated with each of the one or more nodes.

15. The device of claim 1, wherein the one or more processors execute the instructions to display an indication of a completion of one of the one or more blockchain offers.

16. The device of claim 15, wherein, in response to the completion, a payment is processed and delivered to an owner of the respective one or more nodes.

17. The device of claim 1, wherein the centralized blockchain marketplace is used to receive a solicitation or bid for one of the one or more blockchain offers.

18. The device of claim 1, wherein two nodes of the one or more nodes are selected to process the selected one or more blockchain offers.

19. A computer program product comprising computer executable instructions stored on a non-transitory computer readable medium that when executed by a processor instruct the processor to:
access a centralized blockchain marketplace;
select one or more blockchain offers via the centralized blockchain marketplace;
select one or more nodes to process the one or more blockchain offers; and
manage the one or more nodes based on progress metrics associated with each of the one or more blockchain offers.

20. A computer-implemented method, comprising:
accessing a centralized blockchain marketplace;
selecting one or more blockchain offers via the centralized blockchain marketplace;
selecting one or more nodes to process the one or more blockchain offers; and
managing the one or more nodes based on progress metrics associated with each of the one or more blockchain offers.
